(19) United States
(12) Patent Application Publication
(10) Pub. No.: US 2026/0280612 A1
(43) Pub. Date: Sep. 17, 2026

(54) Reconfigurable Intelligent Surface for Assisting a Backscatter Device

(71) Applicant: Telefonaktiebolaget LM Ericsson (publ), Stockholm (SE)

(72) Inventors: Rickard Ljung, Helsingborg (SE); Henrik Sjöland, Lund (SE); Mojtaba Mahdavi, Lund (SE); Shousheng He, Södra Sandby (SE); Magnus Olsson, Klagshamn (SE)

(21) Appl. No.: 19/168,325

(22) PCT Filed: Mar. 8, 2024
(86) PCT No.: PCT/EP2024/056174

§ 371 Date: Sep. 23, 2025

(30) Foreign Application Priority Data
Mar. 24, 2023 (SE) 2330135-1

(51) Int. Cl. H04B 7/04

(52) U.S. Cl. CPC H04B 7/04013

(57) ABSTRACT

There is provided techniques for controlling a reconfigurable intelligent surface. A method comprises receiving, by a second subset of the antenna elements, an information signal from a backscatter device. The method comprises extracting, by a controller, information content from the information signal. The method comprises receiving, by a first subset of antenna elements, an illumination signal from a network node. The method comprises controlling, by the controller, the first subset of antenna elements to reflect the illumination signal back towards the network node, whilst controlling, by the controller, the reflection phases and/or magnitudes of the first subset of antenna elements for the reflected illumination signal to be modulated according to the extracted information content.

### TECHNICAL FIELD

Embodiments presented herein relate to a reconfigurable intelligent surface. Embodiments presented herein further relate to a method, a computer program, and a computer program product for controlling the reconfigurable intelligent surface.

### BACKGROUND

In general terms, a backscatter device uses existing radio frequency signals to transmit data by modulating its antenna reflection and without being equipped with any radio transmitter of its own. A backscatter device may therefore have very limited link budget for its transmitted (backscattered) signal. A drawback when communication via backscatter devices is therefore the need to build a network with a comparatively large amount of network nodes which can listen for the backscattered signal from the backscatter devices. One may need to ensure that the network topology is so dense so that the backscatter devices is never further away than 10-20 meters from the designated network node.

One way to achieve a network topology where each backscatter device has a maximum of 10-20 meters to the closest network node is to build a very dense network with many network nodes, such as transceiver points and/or repeaters. This would thus require a large number of network nodes to be deployed in the area where the backscatter devices are assumed to be located. This would be very costly to implement and also require a large amount of energy to power all the network nodes. This means that for a certain scenario, such as within a factory, a harbor, goods logistics center, or any specific area where there could be an industry relevance to create a good radio environment for low cost, low complexity backscatter devices the required network infrastructure may be too expensive to deploy and/or the total energy consumption might be too high.

An alternative way involves the use of Reconfigurable intelligent surfaces (RISs). In this respect, RISs offer an opportunity for improved wireless communication. Specifically, significant gains are envisioned to be made for millimeter wave spectrum, which is the spectrum used in fifth generation and sixth generation telecommunication systems. This spectrum has serious challenges when it comes to propagation and coverage, e.g., due to its support for very high frequency ranges in tens of GHz. The challenges are larger compared to challenges for spectrum with lower frequencies e.g., for so-called sub-6 GHz frequency bands.

Usage of RIS can vary, but in general an RIS can be configured to reflect wireless signals in a controlled manner, e.g., to steer transmitted signals in a certain direction. This could for example be used to improve overall system coverage, range, and efficiency, and thus enable communication with backscatter devices. RISs are commonly also referred to as large intelligent surfaces, smart reflect-arrays, intelligent reflecting surfaces, passive intelligent mirrors, artificial radio space, and meta-surfaces.

In short, the RIS at its surface comprises an antenna array having multiple (e.g., hundreds or thousands) of antenna elements, or just elements for short. In some aspects, the antenna elements are referred to as atoms. Each element can be individually configured, or controlled, to dynamically adjust the reflecting properties of the surface. The elements are provided rather to modify the properties of a signal by its reflection. The RIS commonly comprises a controller that is configured to transmit control signals to tune the properties of each element in the RIS. One example of this is disclosed in A. Araghi et al., “Reconfigurable Intelligent Surface (RIS) in the Sub-6 GHz Band: Design, Implementation, and Real-World Demonstration,” in IEEE Access, vol. 10, pp. 2646-2655, 2022, doi: 10.1109/ACCESS.2022.3140278. The RIS is thus not transmitting or receiving signals by itself but instead acts as a controllable reflector of signals transmitted and received by other nodes in the system.

One example of using RIS in backscatter communication for short-range and low-power Internet-of-Things (IOT) backscatter devices is proposed in M. Nemati, J. Ding and J. Choi, “Short-Range Ambient Backscatter Communication Using Reconfigurable Intelligent Surfaces,” 2020 IEEE Wireless Communications and Networking Conference (WCNC), 2020, pp. 1-6, doi: 10.1109/WCNC45663.2020.9120813. According to the proposed scheme, the RIS augments the quality of the backscattered signal by compensating the phase distortion effect of multipath propagation channels. However, the proposed scheme still suffers in form of total link budget and therefore it is limited in terms of communication distance (i.e., coverage).

### SUMMARY

An object of embodiments herein is to address the above issues.

According to a first aspect there is presented a reconfigurable intelligent surface. The reconfigurable intelligent surface comprises a first subset of antenna elements provided in a reflective array. Each antenna element in the first subset of antenna elements has a controllable reflection phase and is arranged for reflecting an illumination signal. The reconfigurable intelligent surface comprises a second subset of antenna elements. Each antenna element in the second subset of the antenna elements has a radio chain and is arranged for receiving an information signal. The reconfigurable intelligent surface comprises a controller. The controller is configured to evaluate the information signal received by the second subset of the antenna elements, and to control, based on the evaluated information signal, the reflection phases and/or magnitudes of the first subset of antenna elements, when reflecting the illumination signal. The controller is further configured to control the first subset of antenna elements for the reflective array to reflect the illumination signal in a direction towards a network node whilst controlling the reflection phases and/or magnitudes of the first subset of antenna elements to modulate the reflected illumination signal according to the extracted information.

According to a second aspect there is presented a method for controlling a reconfigurable intelligent surface according to the first aspect. The method comprises receiving, by the second subset of the antenna elements, the information signal from a backscatter device. The method comprises extracting, by the controller, information content from the information signal. The method comprises receiving, by the first subset of antenna elements, the illumination signal from a network node. The method comprises controlling, by the controller, the first subset of antenna elements to reflect the illumination signal back towards the network node, whilst controlling, by the controller, the reflection phases and/or magnitudes of the first subset of antenna elements for the reflected illumination signal to be modulated according to the extracted information content.

According to a third aspect there is presented a reconfigurable intelligent surface. The reconfigurable intelligent surface is configured to perform a method according to the second aspect.

According to a fourth aspect there is presented a computer program comprising computer code which, when run on a reconfigurable intelligent surface, causes the reconfigurable intelligent surface to perform a method according to the second aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects do not suffer from the issues identified above.

Advantageously, for the same network topology, these aspects enable the communication range for a backscatter device to be significantly extended, as well as increasing the performance, e.g., in terms of increased throughput, reduced pathloss, reduced bit error rate, improved channel diversity, etc.

Advantageously, this is achieved by the RIS performing a reflection of the signal from a network node with the information from the backscatter device modulated into the reflection. In this way the RIS is using a significantly better link budget to the network node than from the backscatter device directly.

Advantageously, these aspects enable the existence and operation of the RIS to be completely transparent to both the network node and the backscatter device.

Advantageously, contrary to techniques requiring the addition of further network nodes, the proposed aspects do not require any (new or additional) active device transmitting any signals. With the proposed aspects the network node will receive a stronger signal but need not be informed that it is from the RIS, and the RIS can operate without control or configuration from the network node or the backscatter device. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to an example;

FIG. 2 is a schematic diagram illustrating a communication network according to embodiments;

FIG. 3 schematically illustrates a reflective array according to embodiments;

FIG. 4 schematically illustrates a radio chain according to an embodiment;

FIG. 5 schematically illustrates a radio chain according to an embodiment;

FIG. 6 schematically illustrates timing aspects according to embodiments;

FIG. 7 is a flowchart of methods according to embodiments;

FIG. 8 is a schematic diagram showing functional units of a controller according to an embodiment;

FIG. 9 is a schematic diagram showing functional modules of a controller according to an embodiment; and

FIG. 10 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

At least some of the herein disclosed embodiments are based on, instead of deploying additional active, network nodes, using a passive, device-centric reconfigurable intelligent surface.

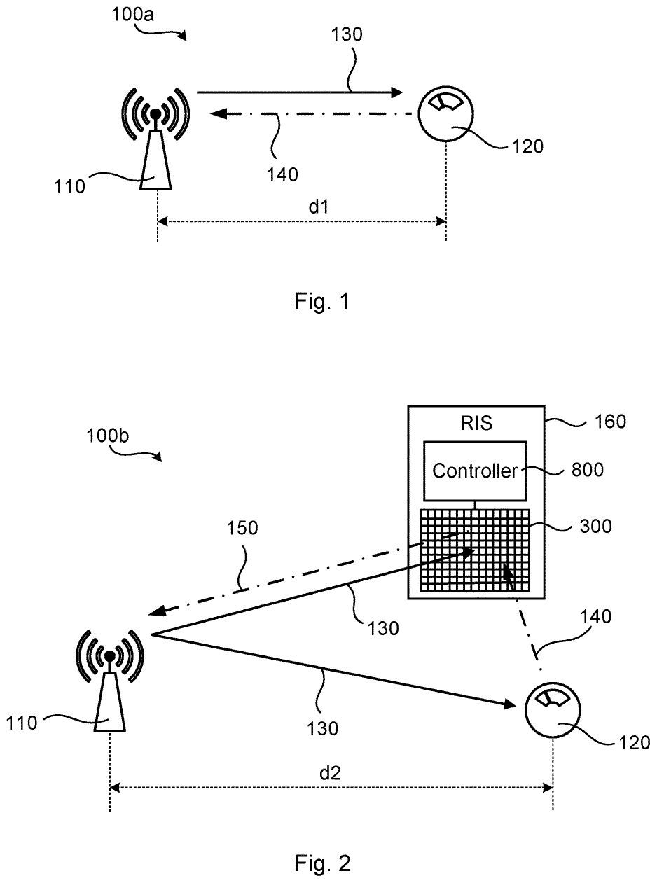

FIG. 1 schematically illustrates a communication network 100a according to an example where a network node 110 and a backscatter device 120 are communicating. The network node 110 transmits an illumination signal 130 towards the backscatter device 120. The backscatter device 120 responds with transmitting an information signal 140 back towards the network node 110, The information signal 140 is a reflection of the illumination signal 130 but modulated to contain information that the backscatter device 120 is to convey to the network node 110. In this way, the backscatter device 120 can communicate information to the network node 110. However, for the information signal 140 to reach the network node 110 with sufficient signal strength for reception, the network node 110 and the backscatter device 120 cannot be separated longer than a distance d1.

As a comparison, FIG. 2 schematically illustrates a communication network 100b where the network node 110 and the backscatter device 120 are communicating according to an embodiment. In comparison to FIG. 1, the communication network 100b further comprises a reconfigurable intelligent surface 160. The reconfigurable intelligent surface 160 comprises a reflective array 300 and a controller 800. According to the communication network 100b, the illumination signal 130 reaches both the backscatter device 120 and the reconfigurable intelligent surface 160. As in FIG. 1, the backscatter device 120, when backscattering the illumination signal 130, includes the information to be transmitted from the backscatter device 120.

The information signal 140 reaches only the reconfigurable intelligent surface 160. As will be further disclosed below, the reconfigurable intelligent surface 160 reflects the illumination signal 130 and whilst doing so modulating the reflected illumination signal 150 to contain the information of the information signal 140 received from the backscatter device 120. Having such a reconfigurable intelligent surface 160 enables the distance between the network node 110 and the backscatter device 120 to be increased from d1 to d2, where d2>>d1. Further details of how the reflective array 300 and the controller 800 are configured to achieve this will be disclosed below.

Hence, the reconfigurable intelligent surface 160 is used as a reflector device to reflect the illumination signal 130 directly back to the network node 110 from where it was transmitted. The reflected illumination signal 150 includes modulated information from the backscatter device 120 by the controller 800 having identified the information contained in the information signal 140 received from the backscatter device 120.

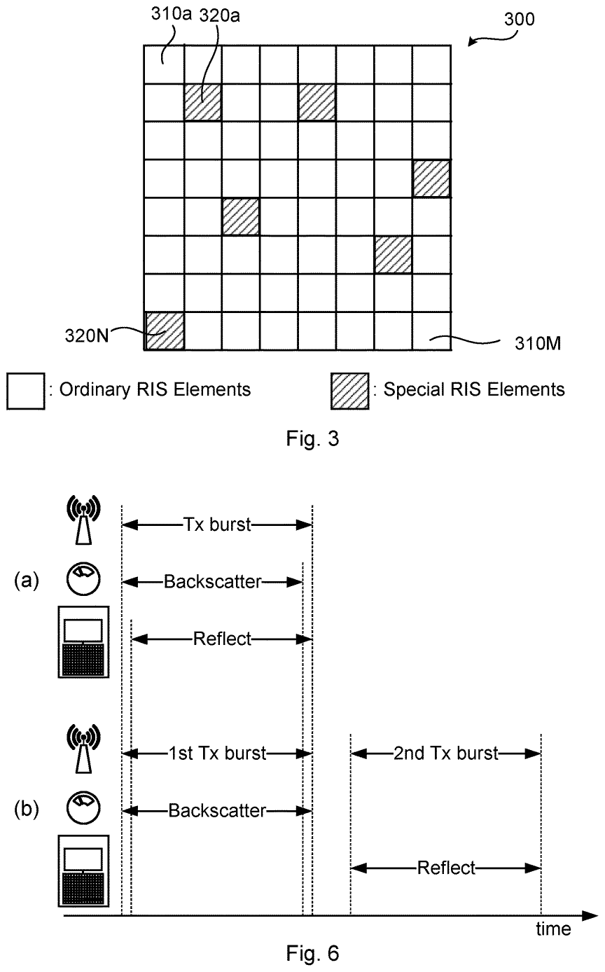

In FIG. 3 is schematically illustrated an embodiment of a reflective array 300 in the form of an 8 -by-8 rectangular antenna array. The reconfigurable intelligent surface 160 comprises a first subset of antenna elements 310a:310M. As noted above, these antenna elements might be referred to as atoms. The first set of antenna elements 310a:310M is provided in the reflective array 300. Each antenna element in the first subset of antenna elements 310a:310M has a controllable reflection phase and is arranged for reflecting the illumination signal 130.

The reconfigurable intelligent surface 160 further comprises a second subset of antenna elements 320a:320N. Each antenna element in the second subset of the antenna elements 320a:320N has a radio chain and is arranged for receiving the information signal 140 from the backscatter device 120.

The information signal 140 from the backscatter device 120 is thereby received by the reconfigurable intelligent surface 160 which can be located much closer to the backscatter device 120 than the network node 110, thus with a much better link budget than for the information signal 140 is reflected directly from the backscatter device 120 to the network node 110, as in FIG. 1.

As in FIG. 2, the reconfigurable intelligent surface 160 further comprises a controller 800. The controller 800 is configured to evaluate the information signal 140 received by the second subset of the antenna elements 320a:320N. The controller 800 is further configured to control, based on the evaluated information signal 140, the reflection phases and/or magnitudes of the first subset of antenna elements 310a:310M, when reflecting the illumination signal 130. The controller 800 is further configured to control the first subset of antenna elements 310a:310M for the reflective array 300 to reflect the illumination signal 130 in a direction towards a network node 110 whilst controlling the reflection phases and/or magnitudes of the first subset of antenna elements 310a:310M to modulate the reflected illumination signal 150 according to the extracted information.

Thus, in order to forward the information from the backscatter device 120, the reflected illumination signal 150 is modulated by the received illumination signal 130. The reconfigurable intelligent surface 160 can in this way include the information from the backscatter device 120 into the reflected illumination signal 150.

Since the reconfigurable intelligent surface 160 can be constructed with a larger reflective array 300 than the backscatter device 120, this enables the reconfigurable intelligent surface 160 to provide a stronger reflected illumination signal 150 towards the network node 110 compared to the information signal 140, but where the reflected illumination signal 150 still conveys the same information as the information signal 140. The larger the area of the reflective array 300, the more improvement.

Advantageously, for the same network topology, the proposed reconfigurable intelligent surface 160 enables the communication range for the backscatter device 120 to be significantly extended, as well as increasing the performance, e.g., in terms of increased throughput, improved link budget, reduced pathloss, reduced bit error rate, improved channel diversity, etc.

Advantageously, this is achieved by the proposed reconfigurable intelligent surface 160 performing a reflection of the illumination signal 130 from the network node 110 with the information from the backscatter device 120 modulated into the reflected illumination signal 150. In this way the reconfigurable intelligent surface 160 is using a significantly better link budget to the network node 110 than from the backscatter device 120 directly.

Advantageously, the existence and operation of the proposed reconfigurable intelligent surface 160 is completely transparent to both the network node 110 and the backscatter device 120.

Advantageously, contrary to techniques requiring the addition of further network nodes 110, the use of the proposed reconfigurable intelligent surface 160 does not require any (new or additional) active device transmitting any signals. With the proposed reconfigurable intelligent surface 160 the network node 110 will receive a stronger reflected illumination signal 150 but need not be informed that it is from the reconfigurable intelligent surface 160, and the reconfigurable intelligent surface 160 can operate without control or configuration from the network node 110 or the backscatter device 120.

There can be different ways in which the second subset of the antenna elements 320a:320N are provided. In the example of FIG. 2, the second subset of the antenna elements 320a:320N are distributed among the first subset of antenna elements 310a:310M in the reflective array 300. However, in other examples, the second subset of the antenna elements 320a:320N are provided in an antenna system separated from the reflective array 300.

Calibration of the reconfigurable intelligent surface 160 will be disclosed next. The calibration is based on using the second subset of the antenna elements 320a:320N to measure on the illumination signal 130 from the network node 110 as well as on the information signal 140 from the backscatter device 120. Measurements can thereby be made to estimate the angle of arrival of the illumination signal 130 as well as to estimate the angle of arrival of the information signal 140.

In some aspects, the calibration of the reconfigurable intelligent surface 160 is made with respect to the direction towards the network node 110. In this respect, the controller 800 might estimate the direction towards the network node 110 to set the direction to reflect the illumination signal 130 directly back to network node 110. The controller 800 can thereby use the illumination signal 130 to determine the spatial properties of the illumination signal 130 from the network node 110. In this respect, the controller 800 can use the second subset of the antenna elements 320a:320N to measure on the illumination signal 130 and thereby locate the direction towards the network node 110, in order for the controller 800 to determine the configuration of the first set of antenna elements 310a:310M to receive and reflect the illumination signal 130 in that direction. Hence, in some embodiments, the controller 800 is further configured to evaluate the direction towards the network node 110 from measurements on the illumination signal 130 as transmitted by the network node 110 and received by the second subset of the antenna elements 320a:320N.

In some aspects, the calibration of the reconfigurable intelligent surface 160 is made with respect to the direction towards the backscatter device 120. In this respect, the controller 800 might use the information signal 140 from the backscatter device 120 to locate the direction towards the backscatter device 120. The controller 800 can thereby use the information signal 140 to determine the spatial properties of the information signal 140 from the backscatter device 120. In other words, the RIS can use the backscattered signal to locate the direction to the backscatter device 120, for beamforming reception of coming information signals 140. Particularly, in some embodiments, the controller 800 is further configured to evaluate a direction towards a backscatter device 120 from measurements on the information signal 140 as backscattered by the backscatter device 120 and received by the second subset of the antenna elements 320a:320N. The controller 800 is further configured to control the second subset of the antenna elements 320a:320N for beamforming in the direction towards the backscatter device 120.

The controller 800 can thereby control the reflective array 300 to direct the reflected illumination signal 150 back to the network node 110 and optionally perform receiver beamforming with respect to the information signal 140 as received from the backscatter device 120. If the backscatter device 120 does not transmit any known information signal 140 for calibration, wide or omnidirectional reception can be used at the reflective array 300.

The calibration can be performed repeatedly e.g., with a repeated time pattern to be able to handle mobility, such as moving backscatter devices 120.

Other examples of reflections of a transmitted illumination signal to a network node can be envisioned. In one or more examples a transmitting network node and a receiving network node of the illumination signal have different geographical locations. In such example the controller is configured to calibrate a direction for reflecting signals from the transmitting node towards the receiving network node.

Aspects of reception of the information signal 140 from the backscatter device 120 will be disclosed next.

The signal processing can be performed in a number of different ways, in digital domain and also partly in analog domain. One objective is to find the information signal 140 in presence of a strong carrier (i.e., simultaneously to also receiving the illumination signal 130). Then the reflection phases and/or magnitudes of the first subset of antenna elements 310a:310M should be set to modulate the reflected illumination signal 150 according to the information extracted from the information signal 140, whilst suppressing feedback of the modulation. The below examples are based on the controller 800 being configured to perform digital domain filtering for separating the information signal 140 from a carrier of the illumination signal 130. The below examples are further based on the controller 800 being configured to extract in-phase (I) and quadrature (Q) components from the received information signal 140 and map the in-phase and quadrature components to reflection phases and/or magnitudes of the first subset of antenna elements 310a:310M.

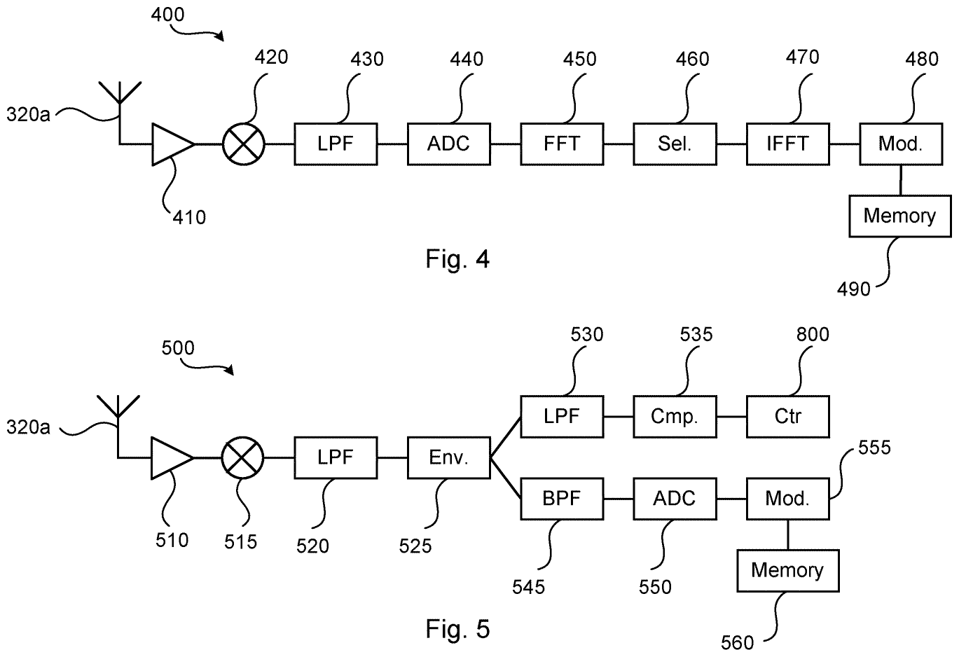

In FIG. 4 is illustrated a first example of how to implement the radio chains 400 of the antenna elements 320a:320N in the second subset of antenna elements. This implementation is based on digital signal processing with Fourier transforms. The signal is received by an antenna element 320a, amplified by an amplifier 410, frequency down-converted by a frequency converter 420, low-pass filtered by a low-pass filter 430, and then in an analog-to-digital converter (ADC) 440 converted to digital form. The signal processing is here thus performed in the digital domain. After application of a Fourier transform (implemented in a fast Fourier transform (FFT) block 450) a selection (Sel.) block 460 identifies the strong carrier and selects the FFT bins at the sides of it, containing the modulation. All other bins are set to zero, and the non-zero bins are moved to positions around the zero-frequency component. Then, conversion back to the time domain is achieved by applying an inverse Fourier transform (implemented as an inverse fast Fourier transform (IFFT) block 470. In this way a time domain signal containing the modulation is achieved. The trajectory of that signal in the I-Q plane is by a modulation (Mod.) block 480 observed in order to determine in the underlying modulation symbol. The reflection phases and/or magnitudes of the first subset of antenna elements 310a:310M can then be set accordingly. Previous transmission can be stored in a memory block 490 so that the effect of previous symbols can be subtracted before calculating the new ones, to suppress feedback.

In FIG. 5 is illustrated a second example of how to implement the radio chains 500 of the antenna elements 320a:320N in the second subset of antenna elements. The signal is received an antenna element 320a, amplified by an amplifier 510, frequency down-converted by a frequency converter 515, low-pass filtered by a low-pass filter 520, and then sent to an envelope (Env.) detector 525. A low-pass filter 530 is configured to average the envelope signal from the envelope detector 525. When the average envelope is above the threshold of the comparator, it can be determined that the carrier is present. The low-pass filtered envelope is thus compared in a compare (Cmp.) block 535 to a threshold and the result is informed to the controller (Ctr.) 800, that then knows if a carrier is present or not. The envelope is also band-pass filtered in a band-pass filter 545, to filter out the modulation. The filtered signal is converted to digital form in an ADC 550, which can be done with rather low bandwidth, and hence low power consumption. The received amplitude modulation is by a modulation (Mod.) block 555 analyzed to determine in the underlying modulation symbol. The reflection phases and/or magnitudes of the first subset of antenna elements 310a:310M can then be set accordingly. Previous transmission can be stored in a memory block 560 so that the effect of previous symbols can be subtracted before calculating the new ones, to suppress feedback. It is noted that the phase of the carrier of the illumination signal 130 as received from the network node 110 may be different from the information signal 140 as received from the backscatter device 120. The modulation sidebands could therefore have a phase providing amplitude modulation, phase modulation, or anything is between. But by using multiple antenna elements 320a:320N in the second subset of antenna elements provided at different locations in the reflective array 300 it will still be possible to detect the modulation by the envelope detectors of the different radio chains (one per antenna element).

An alternative to the second example is to place the ADC earlier in the signal chain, for example after the first low-pass filter, and perform more processing in the digital domain. This could allow for a simpler realization of the envelope detector, and also allow different frequency bands to be filtered out in the baseband to reduce interference.

Aspects of how the magnitudes of the first subset of antenna elements 310a:310M can be controlled for reflecting the illumination signal 130 will be disclosed next.

In some examples, the controller 800 is further configured to control the reflection phases and/or magnitudes of the first subset of antenna elements 310a:310M by setting one impedance value for each of the antenna element in the first subset of antenna elements 310a:310M based on the in-phase and quadrature components. In some examples, the controller 800 is further configured to control the magnitudes of the first subset of antenna elements 310a:310M for reflecting the illumination signal 130 by selectively setting at least some of the antenna element in the first subset of antenna elements 310a:310M in an absorbing state. Setting the antenna elements in the absorbing state implies that the antenna elements are terminated by a matched impedance. Different levels of amplitude modulation can be achieved by setting a subset of varying size in the absorbing state, or all antenna elements could be modulated to achieve on/off keying.

Further, amplitude modulation can be performed by changing the reflection phases of the first subset of antenna elements 310a:310M to shift the beam direction or de-focus the beam for the reflected illumination signal 150 such that less energy reaches the network node 110, or by reducing the amplitude of the reflection by absorbing the wave, by changing the impedances terminating the first subset of antenna elements 310a:310M to ones more towards the center of the Smith chart, being more resistive.

FIG. 6 schematically illustrates two examples of timing aspects with respect to reception of the information signal 140 from the backscatter device 120 and reflection of the illumination signal 130 back towards the network node 110.

According to a first example, the controller 800 is further configured to evaluate the information signal 140 received by the second subset of the antenna elements 320a:320N, and to control the reflection phases and/or magnitudes of the first subset of antenna elements 310a:310M, when reflecting the illumination signal 130, based on the evaluated information signal 140 during one and the same burst of the illumination signal 130. An example of this is illustrated in FIG. 6(a). Here, “Tx burst” represents one burst of the illumination signal 130, “Backscatter” represents the information signal 140 and “Reflect” represents the reflected illumination signal 150. The delay of the reflected illumination signal 150 compared to the information signal 140 is caused by internal processing delay in the reconfigurable intelligent surface 160.

According to a second example, the controller 800 is further configured to evaluate the information signal 140 received by the second subset of the antenna elements 320a:320N during a first burst of the illumination signal 130, and to control the reflection phases and/or magnitudes of the first subset of antenna elements 310a:310M, when reflecting the illumination signal 130, based on the evaluated information signal 140 during a second burst of the illumination signal 130. An example of this is illustrated in FIG. 6(b). Here, “1st Tx burst” represents a first burst of the illumination signal 130, “2n Tx burst” represents a second burst of the illumination signal 130, “Backscatter” represents the information signal 140 and “Reflect” represents the reflected illumination signal 150. Here, during the first burst of the illumination signal 130 the information signal 140 is received (and processed) by the reconfigurable intelligent surface 160, and during the second burst of the illumination signal 130 the reconfigurable intelligent surface 160 reflects the illumination signal, where the reflected illumination signal is modulated according to the information content as extracted from the information signal 140 received during the first burst of the illumination signal 130.

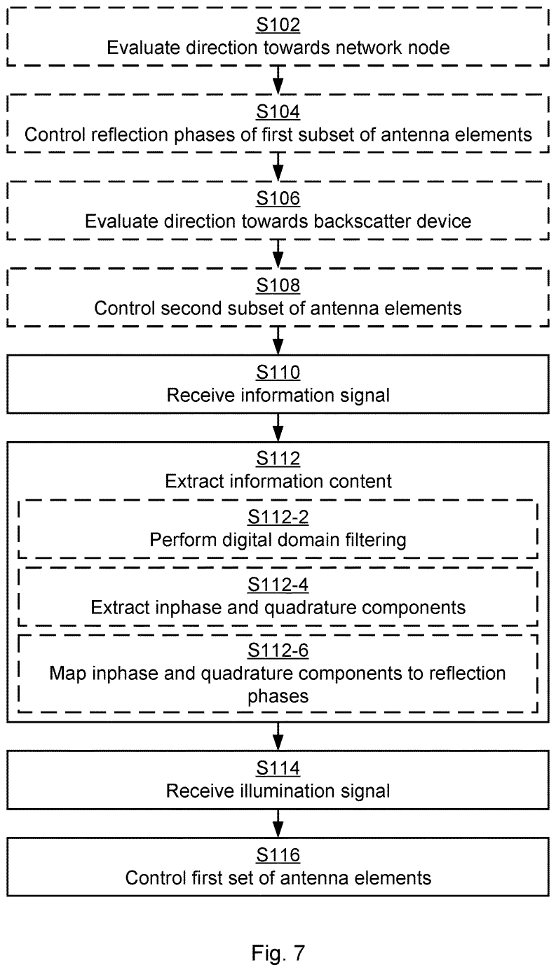

FIG. 7 is a flowchart illustrating embodiments of methods for controlling a reconfigurable intelligent surface 160 as disclosed above.
S110: The information signal 140 is by the second subset of the antenna elements 320a:320N received from a backscatter device 120.
S112: The controller 800 extracts information content from the information signal 140.
S114: The illumination signal 130 is by the first subset of antenna elements 310a:310M received from a network node 110.
S116: The controller 800 controls the first subset of antenna elements 310a:310M to reflect the illumination signal 130 back towards the network node 110 whilst also controlling the reflection phases and/or magnitudes of the first subset of antenna elements 310a:310M for the reflected illumination signal 150 to be modulated according to the extracted information content.

Embodiments relating to further details of controlling the reconfigurable intelligent surface 160 will now be disclosed with continued reference to FIG. 7.

As noted above, in some aspects, a calibration of the reconfigurable intelligent surface 160 is made with respect to the direction towards the network node 110. In particular, in some embodiments, the method therefore comprises optional steps S102, S104.
S102: The controller 800 evaluates the direction towards the network node 110 from measurements on the illumination signal 130 as transmitted by the network node 110 and received by the second subset of the antenna elements 320a:320N.
S104: The controller 800 controls the reflection phases of the first subset of antenna elements 310a:310M for the reflective array 300 to reflect the illumination signal 130 in the direction towards the network node 110.

As further noted above, in some aspects, a calibration of the reconfigurable intelligent surface 160 is made with respect to the direction towards the backscatter device 120. In particular, in some embodiments, the method therefore comprises optional steps S106, S108.
S106: The controller 800 evaluates a direction towards the backscatter device 120 from measurements on the information signal 140 as backscattered by the backscatter device 120 and received by the second subset of the antenna elements 320a:320N.
S108: The controller 800 controls the second subset of the antenna elements 320a:320N for beamforming in the direction towards the backscatter device 120.

Examples have been provided above that are based on the controller 800 being configured to perform digital domain filtering for separating the information signal 140 from a carrier of the illumination signal 130. Hence, in some aspects, the method comprises (optional) step S112-2 to be performed as part of step S112.
S112-2: The controller 800 performs digital domain filtering for separating the information signal 140 from a carrier of the illumination signal 130.

The above examples are further based on the controller 800 being configured to extract in-phase and quadrature components from the received information signal 140 and map the in-phase and quadrature components to reflection phases and/or magnitudes of the first subset of antenna elements 310a:310M.

Hence, in some aspects, the method comprises (optional) steps S112-4 and S112-6 to be performed as part of step S112.
S112-4: The controller 800 extracts in-phase and quadrature components from the received information signal 140.
S112-6: The controller 800 maps the in-phase and quadrature components to reflection phases and/or magnitudes of the first subset of antenna elements 310a:310M.

As disclosed above, the reflection phases and/or magnitudes of the first subset of antenna elements 310a:310M might be controlled by the controller 800 setting one impedance value for each of the antenna element in the first subset of antenna elements 310a:310M based on the in-phase and quadrature components. As further disclosed above, the magnitudes of the first subset of antenna elements 310a:310M for reflecting the illumination signal 130 might be controlled by selectively setting at least some of the antenna element in the first subset of antenna elements 310a:310M in an absorbing state.

As disclosed above, according to a first example, the information signal 140 is received from the backscatter device 120 and the illumination signal 130 is reflected back towards the network node 110 during one and the same burst of the illumination signal 130. As disclosed above, according to a second example, the information signal 140 is received from the backscatter device 120 during a first burst of the illumination signal 130 and the illumination signal 130 is reflected back towards the network node 110 during a second burst of the illumination signal 130.

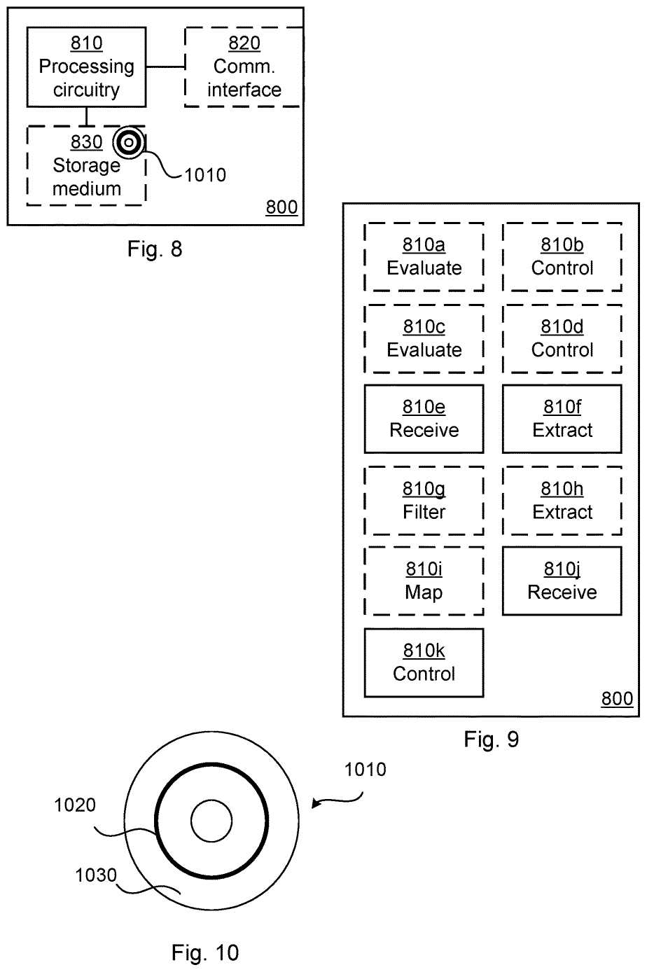

FIG. 8 schematically illustrates, in terms of a number of functional units, the components of a controller 800 according to an embodiment. Processing circuitry 810 is provided using any combination of one or more of a suitable central processing unit (CPU), multiprocessor, microcontroller, digital signal processor (DSP), etc., capable of executing software instructions stored in a computer program product 1010 (as in FIG. 10), e.g. in the form of a storage medium 830. The processing circuitry 810 may further be provided as at least one application specific integrated circuit (ASIC), or field programmable gate array (FPGA).

Particularly, the processing circuitry 810 is configured to cause the controller 800 to perform a set of operations, or steps, as disclosed above. For example, the storage medium 830 may store the set of operations, and the processing circuitry 810 may be configured to retrieve the set of operations from the storage medium 830 to cause the controller 800 to perform the set of operations. The set of operations may be provided as a set of executable instructions.

Thus the processing circuitry 810 is thereby arranged to execute methods as herein disclosed. The storage medium 830 may also comprise persistent storage, which, for example, can be any single one or combination of magnetic memory, optical memory, solid state memory or even remotely mounted memory. The controller 800 may further comprise a communications (comm.) interface 820 at least configured for communications at least configured for communications with other components, or entities, within the reconfigurable intelligent surface 160. As such the communications interface 820 may comprise one or more transmitters and receivers, comprising analogue and digital components. The processing circuitry 810 controls the general operation of the controller 800 e.g. by sending data and control signals to the communications interface 820 and the storage medium 830, by receiving data and reports from the communications interface 820, and by retrieving data and instructions from the storage medium 830. Other components, as well as the related functionality, of the controller 800 are omitted in order not to obscure the concepts presented herein.

FIG. 9 schematically illustrates, in terms of a number of functional modules, the components of a controller 800 according to an embodiment. The controller 800 of FIG. 9 comprises a number of functional modules; a receive module 810e configured to perform step S110, an extract module 810f configured to perform step S112, a receive module 810j configured to perform step S114, and a control module 810k configured to perform step S116. The controller 800 of FIG. 9 may further comprise a number of optional functional module 810s, such as any of an evaluate module 810a configured to perform step S102, a control module 810b configured to perform step S104, an evaluate module 810c configured to perform step S106, a control module 810d configured to perform step S108, a filter module 810g configured to perform step S112-2, an extract module 810h configured to perform step S112-4, and a map module 810i configured to perform step S112-6.

In general terms, each functional module 810a:810k may in one embodiment be implemented only in hardware and in another embodiment with the help of software, i.e., the latter embodiment having computer program instructions stored on the storage medium 830 which when run on the processing circuitry makes the controller 800 perform the corresponding steps mentioned above in conjunction with FIG. 9. It should also be mentioned that even though the modules correspond to parts of a computer program, they do not need to be separate modules therein, but the way in which they are implemented in software is dependent on the programming language used. Preferably, one or more or all functional modules 810a:810k may be implemented by the processing circuitry 810, possibly in cooperation with the communications interface 820 and/or the storage medium 830. The processing circuitry 810 may thus be configured to from the storage medium 830 fetch instructions as provided by a functional module 810a:810k and to execute these instructions, thereby performing any steps as disclosed herein.

The controller 800 may be provided as a standalone device or as a part of at least one further device. For example, as disclosed above the controller 800 might be provided in the reconfigurable intelligent surface 160.

FIG. 10 shows one example of a computer program product 1010 comprising computer readable storage medium 1030. On this computer readable storage medium 1030, a computer program 1020 can be stored, which computer program 1020 can cause the processing circuitry 810 and thereto operatively coupled entities and devices, such as the communications interface 820 and the storage medium 830, to execute methods according to embodiments described herein. The computer program 1020 and/or computer program product 1010 may thus provide means for performing any steps as herein disclosed.

In the example of FIG. 10, the computer program product 1010 is illustrated as an optical disc, such as a CD (compact disc) or a DVD (digital versatile disc) or a Blu-Ray disc. The computer program product 1010 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020 is here schematically shown as a track on the depicted optical disk, the computer program 1020 can be stored in any way which is suitable for the computer program product 1010.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-23. (canceled)

24. A reconfigurable intelligent surface, comprising:
a first subset of antenna elements provided in a reflective array, wherein each antenna element in the first subset of antenna elements has a controllable reflection phase and is arranged for reflecting an illumination signal;
a second subset of antenna elements, wherein each antenna element in the second subset of the antenna elements has a radio chain and is arranged for receiving an information signal; and
a controller, wherein the controller is configured to evaluate the information signal received by the second subset of the antenna elements, and to control, based on the evaluated information signal, the reflection phases and/or magnitudes of the first subset of antenna elements, when reflecting the illumination signal; and
wherein the controller further is configured to control the first subset of antenna elements for the reflective array to reflect the illumination signal in a direction towards a network node whilst controlling the reflection phases and/or magnitudes of the first subset of antenna elements to modulate the reflected illumination signal based on information extracted from the information signal.

25. The reconfigurable intelligent surface of claim 24, wherein the second subset of the antenna elements are distributed among the first subset of antenna elements in the reflective array.

26. The reconfigurable intelligent surface of claim 24, wherein the second subset of the antenna elements are provided in an antenna system separated from the reflective array.

27. The reconfigurable intelligent surface of claim 24, wherein the controller is configured to evaluate the direction towards the network node from measurements on the illumination signal as transmitted by the network node and received by the second subset of the antenna elements.

28. The reconfigurable intelligent surface of claim 24, wherein the controller is configured to evaluate a direction towards a backscatter device from measurements on the information signal as backscattered by the backscatter device and received by the second subset of the antenna elements, and to control the second subset of the antenna elements for beamforming in the direction towards the backscatter device.

29. The reconfigurable intelligent surface of claim 24, wherein the controller is configured to perform digital domain filtering for separating the information signal from a carrier of the illumination signal.

30. The reconfigurable intelligent surface of claim 24, wherein the controller is configured to extract in-phase and quadrature components from the received information signal and map the in-phase and quadrature components to reflection phases and/or magnitudes of the first subset of antenna elements.

31. The reconfigurable intelligent surface of claim 30, wherein the controller is configured to control the reflection phases and/or magnitudes of the first subset of antenna elements by setting one impedance value for each of the antenna element in the first subset of antenna elements based on the in-phase and quadrature components.

32. The reconfigurable intelligent surface of claim 24, wherein the controller is configured to control the magnitudes of the first subset of antenna elements for reflecting the illumination signal by selectively setting at least some of the antenna element in the first subset of antenna elements in an absorbing state.

33. The reconfigurable intelligent surface of claim 24, wherein the controller is configured to evaluate the information signal received by the second subset of the antenna elements, and to control the reflection phases and/or magnitudes of the first subset of antenna elements, when reflecting the illumination signal, based on the evaluated information signal during one and the same burst of the illumination signal.

34. The reconfigurable intelligent surface of claim 24, wherein the controller is configured to evaluate the information signal received by the second subset of the antenna elements during a first burst of the illumination signal, and to control the reflection phases and/or magnitudes of the first subset of antenna elements, when reflecting the illumination signal, based on the evaluated information signal during a second burst of the illumination signal.

35. A method for controlling the reconfigurable intelligent surface of claim 24, wherein the method comprises:
receiving, by the second subset of the antenna elements, the information signal from a backscatter device;
extracting, by the controller, information content from the information signal;
receiving, by the first subset of antenna elements, the illumination signal from a network node; and
controlling, by the controller, the first subset of antenna elements to reflect the illumination signal back towards the network node, whilst controlling, by the controller, the reflection phases and/or magnitudes of the first subset of antenna elements for the reflected illumination signal to be modulated based on the extracted information content.

36. The method of claim 35, wherein the method further comprises:
evaluating, by the controller, the direction towards the network node from measurements on the illumination signal as transmitted by the network node and received by the second subset of the antenna elements; and
controlling, by the controller, the reflection phases of the first subset of antenna elements the reflective array to reflect the illumination signal in the direction towards the network node.

37. The method of claim 35, wherein the method further comprises:
evaluating, by the controller, a direction towards the backscatter device from measurements on the information signal as backscattered by the backscatter device and received by the second subset of the antenna elements; and
controlling, by the controller, the second subset of the antenna elements for beamforming in the direction towards the backscatter device.

38. The method of claim 35, wherein extracting the information content comprises:
performing, by the controller, digital domain filtering for separating the information signal from a carrier of the illumination signal.

39. The method of claim 35, wherein extracting the information content comprises:
extracting, by the controller, in-phase and quadrature components from the received information signal; and
mapping, by the controller, the in-phase and quadrature components to reflection phases and/or magnitudes of the first subset of antenna elements.

40. The method of claim 39, wherein the reflection phases and/or magnitudes of the first subset of antenna elements are controlled by the controller setting one impedance value for each of the antenna element in the first subset of antenna elements based on the in-phase and quadrature components.

41. The method of claim 35, wherein the magnitudes of the first subset of antenna elements for reflecting the illumination signal are controlled by selectively setting at least some of the antenna element in the first subset of antenna elements in an absorbing state.

42. The method of claim 35, wherein the information signal is received from the backscatter device and the illumination signal is reflected back towards the network node during one and the same burst of the illumination signal.

43. The method of claim 35, wherein the information signal is received from the backscatter device during a first burst of the illumination signal and the illumination signal is reflected back towards the network node during a second burst of the illumination signal.
